(19) United States
(12) Patent Application Publication
(10) Pub. No.: US 2018/0306274 A1
(43) Pub. Date: Oct. 25, 2018

(54) Carrier and Sun Gear Set for use in a Transmission

(71) Applicant: DeFeo Manufacturing, Inc., Brookfield, CT (US)

(72) Inventors: Anthony Defeo, Brookfield, CT (US); Austin Nesser, Brookfield, CT (US)

(21) Appl. No.: 15/959,996

(22) Filed: Apr. 23, 2018

Related U.S. Application Data
(60) Provisional application No. 62/488,494, filed on Apr. 21, 2017.

(51) Int. Cl. F16H 1/28; F16H 63/30

(52) U.S. Cl. CPC F16H 1/28; F16H 2001/327; F16H 63/30

(57) ABSTRACT

A system and method for modifying a stock transmission is provided. The stock transmission includes an existing ring gear and main shaft. A modified gearset is provided, wherein the modified gearset is capable of replacing a stock gearset that includes at least a stock sun gear and at least a stock pinion gear. The modified gearset includes a replacement sun gear, the replacement sun gear having an increased tooth count and an increased diameter as compared to the stock sun gear. The modified gearset further includes a replacement pinion gear, the replacement pinion gear having a decreased tooth count and a decreased diameter as compared to the stock pinion gear. The replacement sun gear and the replacement pinion gear are capable of meshing with the existing ring gear. Accordingly, the stock transmission performance can be modified with minimal modifications to the stock transmission itself.

### CROSS-REFERENCE TO RELATED APPLICATIONS

This application claims priority under 35 U.S.C. § 119 to U.S. Provisional Application Ser. No. 62/488,494, filed Apr. 21, 2017, which is hereby incorporated by reference in its entirety.

### TECHNICAL FIELD

The present invention is related to modified gear sets and, as a more particular example, a modified gear set that can be incorporated into an existing transmission system.

### BACKGROUND

Some vehicles equipped with an existing transmission, such as an Allison LCT Transmission, manufactured by Allison Transmissions, Inc., for example, require greater output speeds of the transmissions to increase their speed/acceleration. The current stock configuration of these LCT Allison Transmissions does not satisfactorily meet the needs of these users of these vehicles, and altering the gear ratios of the transmission is impossible for the typical user. The present invention as described herein solves these and other problems.

### SUMMARY OF THE INVENTION

In one aspect of the invention, a transmission having an existing ring gear and main shaft is and having a modified gearset is provided. The modified gearset is capable of replacing a stock gearset that includes at least a stock sun gear having a stock diameter and tooth count and at least a stock pinion gear having a stock diameter and tooth count. A replacement sun gear, the replacement sun gear having an increased tooth count and an increased diameter as compared to the stock sun gear is provided. A replacement pinion gear, the replacement pinion gear having a decreased tooth count and a decreased diameter as compared to the stock pinion gear is also provided. The replacement sun gear and the replacement pinion gear are capable of meshing with the existing ring gear.

According to a further aspect, the replacement sun gear has 57 teeth and the replacement pinion gear has 23 teeth.

According to a still further aspect, the transmission includes a replacement carrier, the replacement sun gear and the replacement pinion gear being supported by the replacement carrier.

According to a further aspect, the replacement carrier includes notches that have a reduced size as compared to stock notches

According to a still further aspect, the replacement carrier defines spindle receiving holes, wherein the spindle receiving holes are located along a larger diameter pattern as compared to a stock carrier and the material thickness in the area surrounding the spindle receiving holes is increased as compared to the stock carrier.

According to a further aspect, the transmission includes a replacement spindle, wherein the replacement pinion gear is disposed about the replacement spindle, wherein the replacement spindle has a reduced diameter as compared to a stock spindle.

According to another aspect, a method of modifying a stock transmission having an existing ring gear and main shaft is provided. The stock transmission includes a stock gearset that includes at least a stock sun gear having a stock diameter and tooth count and at least a stock pinion gear having a stock diameter and tooth count. The method comprises the steps of removing the stock sun gear and removing the stock pinion gear. A replacement sun gear is installed, the replacement sun gear having an increase tooth count and an increased diameter as compared to the stock sun gear. A replacement pinion gear is installed, the replacement pinion gear having a decreased tooth count and a decreased diameter as compared to the stock pinion gear. The replacement sun gear and the replacement pinion gear are capable of meshing with the existing ring gear.

According to a further aspect, the replacement sun gear has 57 teeth and the replacement pinion gear has 23 teeth.

According to a still further aspect, the method further includes the step of installing a replacement carrier, the replacement sun gear and the replacement pinion gear being supported by the replacement carrier, the replacement carrier having notches that have a reduced size as compared to stock notches.

According to a further aspect, the replacement carrier defines spindle receiving holes, wherein the spindle receiving holes are located along a larger diameter pattern as compared to a stock carrier and the material thickness in the area surrounding the spindle receiving holes is increased as compared to the stock carrier.

According to a still further aspect, the method further includes the step of installing a replacement spindle, wherein the replacement pinion gear is disposed about the replacement spindle, wherein the replacement spindle has a reduced diameter as compared to a stock spindle.

### BRIEF DESCRIPTION OF THE DRAWINGS

FIG. 1. shows an exploded view of a gearset in accordance with one embodiment of the present invention;

FIG. 2 shows a close-up view of a carrier of FIG. 1;

FIG. 3 shows a close-up view of a sun gear of FIG. 1;

FIG. 4 shows a close-up view of a pinion gear of FIG. 1;

FIG. 5 shows a close-up view of a spindle of FIG. 1;

FIG. 6 shows a close-up view of an assembled carrier and sun gear of FIG. 1;

FIG. 7A shows a close-up view of a portion of a carrier of FIG. 1; and

FIG. 7B shows a portion of a stock carrier.

### DETAILED DESCRIPTION OF CERTAIN EMBODIMENTS OF THE INVENTION

This invention allows the user to easily alter the gear ratios of their transmission, by replacing the P3 Planetary Carrier and P3 Sun Gear with a gearset modified according to the present invention, which is sometimes referred to herein as the “P282A” invention. Since the Allison LCT Transmission, for example, is monitored by output speed sensors, the TCM requires modification of the ratio tables for the invention to function properly.

The gear ratios achieved by this alteration are significantly lower than those found in the stock close ratio configurations, allowing vehicles to achieve higher speeds without having to change transmissions entirely to achieve this result. Due to the fact that the gear set of the present invention is specifically structured to couple with an existing transmission system, the physical replacement of the P3 Planetary Carrier and P3 Sun Gear is made simple by the present invention, requiring only the same tools required to dis-assemble and assemble the transmission normally. The present invention is designed to require no additional mechanical modifications to implement except those listed below, allowing the user to implement the pieces without removing and altering their own parts.

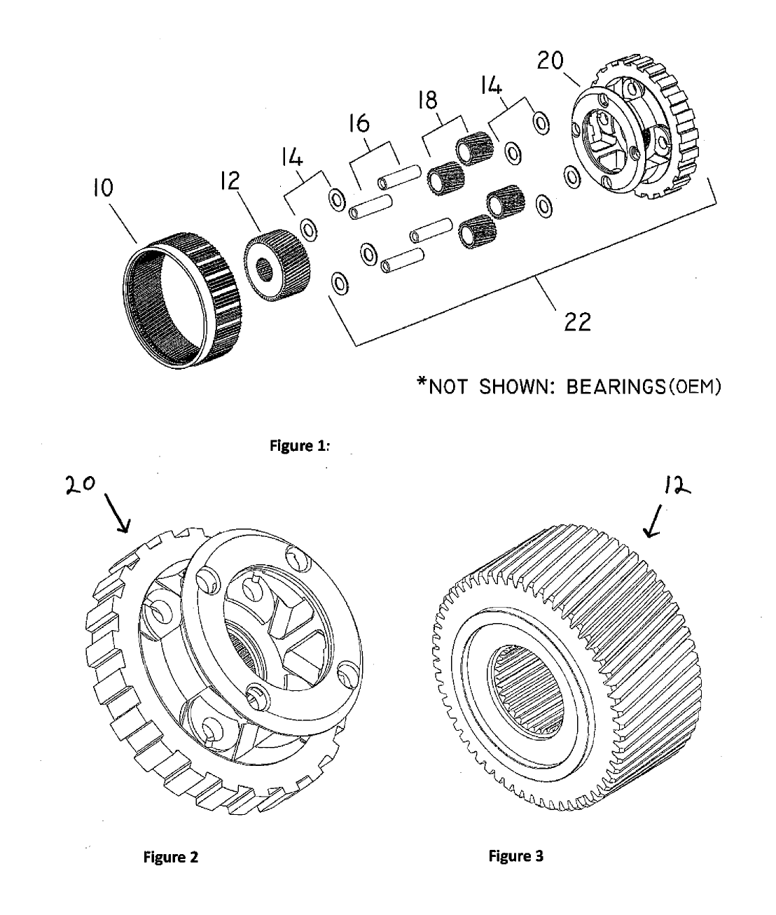

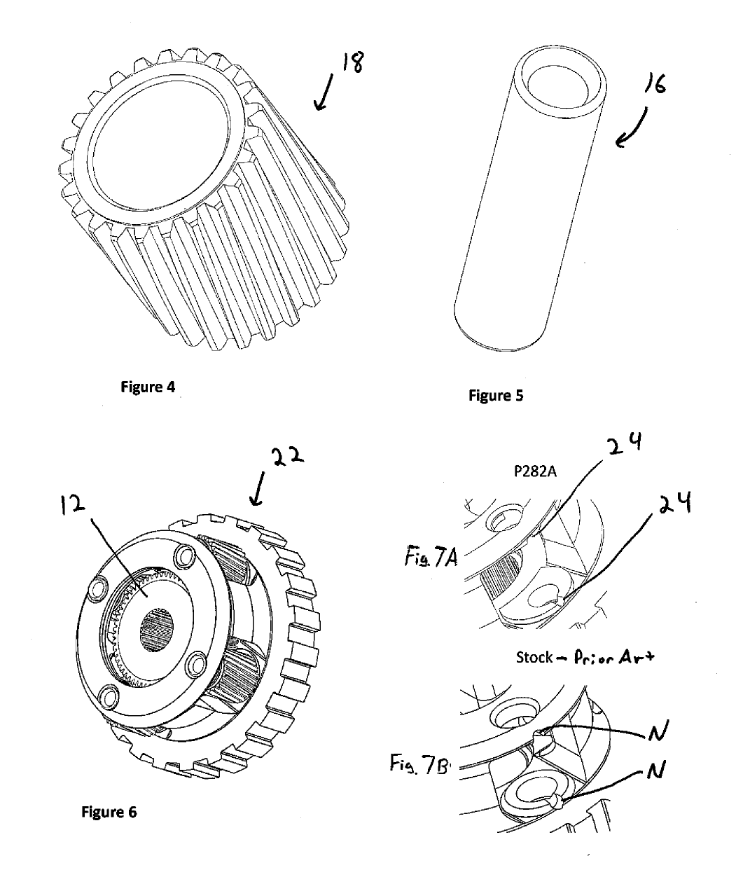

Referring to FIGS. 1-7A, the change in gear ratio is achieved by reducing the diameter and tooth count of the pinion gears 18 on the carrier 20 and increasing that of the sun gear 12. As shown in FIG. 1, the illustrated gearset includes one sun gear 12 and four pinion gears 18. The pinion gears 18 and sun gear 12 are designed to mesh with existing pieces in the transmission, in particular the ring gear 10 and main shaft (not shown on FIG. 1). Any alterations to the ring gear 10 would have required alterations to be made to the P2 Carrier (not shown on FIG. 1). This was avoided by ensuring the ring gear 10 would not have to be changed.

Certain limitations exist regarding the potential sizes available to gears in a carrier. The number of teeth on the sun gear 12 (S) plus the twice number of teeth on the pinion gears 18 (P) must equal the number of teeth on the ring gear 10 (R) in order for the teeth to mesh properly. In addition, the number of teeth on the sun gear 12 plus the number of teeth by on the ring gear 10 must divide evenly by the number of pinion gear 18 (N) to a whole number (I). These two requirements are summarized below.

$$\begin{matrix}S + 2 * P = R & Eq ( 1 ) \\ \frac{S + R}{N} = I & Eq ( 2 )\end{matrix}$$

In addition, in order for gears to mesh properly, they must share a common diametric pitch and pressure angle. This diametric pitch and pressure angle must match that of the ring gear 10 used in order to interface with the rest of the transmission.

The actual transmission gear ratios themselves are calculated on the basis of the double clutch configuration used by these 5 speed transmissions, building off of the base formula:

(R+S)*T_{y}=R*Tᵣ+S*Tₛ Eq(3)

Where T_{y} is the number of turns of the carrier, Tᵣ is the number of turns of the ring gear, and Tₛ is the number of turns of the sun gear. For the relevant transmission, the gear ratios of each gear are calculated as follows:

$$\begin{matrix}Gear 1 = \frac{P 3 R + P 3 S}{P 3 S} & Eq ( 4 ) \\ Gear 2 = \frac{P 3 R + P 3 S}{P 3 R * ( \frac{P 2 S}{P 2 S + P 2 R} ) + P 3 S} & Eq ( 5 ) \\ Gear 3 = \frac{P 3 R + P 3 S}{P 3 S + ( P 3 R ) * \frac{( P 2 S + \frac{P 2 R * P 1 S}{P 1 R + P 1 S} )}{P 2 R + P 2 S}} & Eq ( 6 ) \\ Gear 5 = \frac{P 3 R + P 3 S}{P 3 R + ( \frac{P 3 S}{P 2 S} ) * ( ( P 2 S + P 2 R ) - \frac{P 2 R * P 1 S}{P 1 R + P 1 S} )} & Eq ( 8 ) \\ Reverse = ( 1 + \frac{P 1 R}{P 1 S} ) * ( \frac{P 2 S}{P 2 R} ) * ( 1 + \frac{P 3 R}{P 3 S} ) & Eq ( 9 )\end{matrix}$$

Where P1, P2, and P3 refer to which planetary carrier the gears belong, while R and S refer to which member of the planetary set the teeth count refers to (sun or ring).

These formulas, with the constraints specified, were used to determine what possible alternatives were available, while still maintaining the remainder of the gear train (i.e. only altering the P3 planetary carrier assembly 22 and sun gear 12). The resulting carrier assembly 22 chosen has 23 teeth on each pinion gear 18 and 57 teeth on the sun gear 12. The resulting gear ratios and the comparable alternative are shown below.

| Gear | Stock | P282A |
|---|---|---|
| 1 | 3.10 | 2.81 |
| 2 | 1.81 | 1.74 |
| 3 | 1.41 | 1.38 |
| 4 | 1 | 1 |
| 5 | 0.71 | 0.69 |
| R | 4.49 | 4.06 |

The pinion 18 and sun gears 12 according to an embodiment of the present invention were designed with these teeth counts. The carrier 20 was significantly altered in order to allow for the difference in pinion and sun gear sizes, expanding the location diameter of the holes for the spindles 16. Additional material is added to the casting in areas surrounding the spindles 18, in order to reduce the possibility of a crack at this area. The spindles 16 are designed to be significantly smaller diameter than those used on the stock carrier, in order to reduce the amount of material removed when machining the carrier 20. The inside of the carrier 20 is machined to a greater diameter than the stock carrier, allowing for oil to flow around and under the sun gear 12. Compared to stock pieces, the sun gear 12 is significantly greater in diameter, while the pinion gears 18 are significantly smaller in outer diameter, reflecting the change in tooth count for each of these gears. The inner diameter of the pinion gears 18 is reduced in order to maintain the wall thickness of the pinion. OEM bearings and thrust washers of appropriate size are used.

In addition, the notches 24 in the carrier 20 used to provide oil to the bearings of the pinion gears 18 have been reduced in size, as shown in FIG. 7A, in order to increase the amount of material surrounding the spindles 16. As can be seen in the Stock-Prior Art carrier, as shown in FIG. 7B, the notches N are significantly larger in size. In addition, these smaller notches 24 are meant to increase the pressure of the oil flowing through the bearings to better remove debris that may get caught inside the pinion gears during operation. This change in notch size does not impede the carrier's 20 ability to mate with the surrounding ring gear 10.

The result is a P3 planetary carrier 22 and sun gear 12 set that is able to be used with the existing gear train of the transmission, which alters the gear ratio of that transmission to better suit the needs of users seeking greater output speeds. The new gear ratios must be programmed into the TCM of the transmission, either by the user or by replacing the TCM with a reprogrammed one.

This invention can be installed in vehicles containing Allison LCT transmissions, for example, to increase the gear ratio of their transmissions, in order to achieve higher speeds. The same technique for the creation of this invention can be applied to other transmissions, allowing for greater degrees of customization without sacrificing simplicity.

The invention has been described with regard to certain embodiments thereof to aid in an understanding thereof, but the invention itself is more broadly defined by the recitations in any claims appended hereto, and equivalents of such recitations, and the claims are to be read with that in mind.

1. A transmission having an existing ring gear and main shaft and having a modified gearset, wherein the modified gearset is capable of replacing a stock gearset that includes at least a stock sun gear having a stock diameter and tooth count and at least a stock pinion gear having a stock diameter and tooth count, comprising:
a replacement sun gear, the replacement sun gear having an increased tooth count and an increased diameter as compared to the stock sun gear; and
a replacement pinion gear, the replacement pinion gear having a decreased tooth count and a decreased diameter as compared to the stock pinion gear;
wherein the replacement sun gear and the replacement pinion gear are capable of meshing with the existing ring gear.

2. The transmission of claim 1, wherein the replacement sun gear has 57 teeth and the replacement pinion gear has 23 teeth.

3. The transmission of claim 1, further including a replacement carrier, the replacement sun gear and the replacement pinion gear being supported by the replacement carrier.

4. The transmission of claim 3, wherein the replacement carrier includes notches that have a reduced size as compared to stock notches.

5. The transmission of claim 3, wherein the replacement carrier defines spindle receiving holes, wherein the spindle receiving holes are located along a larger diameter pattern as compared to a stock carrier and the material thickness in the area surrounding the spindle receiving holes is increased as compared to the stock carrier.

6. The transmission of claim 1, further including a replacement spindle, wherein the replacement pinion gear is disposed about the replacement spindle, wherein the replacement spindle has a reduced diameter as compared to a stock spindle.

7. A method of modifying a stock transmission having an existing ring gear and main shaft and having a stock gearset that includes at least a stock sun gear having a stock diameter and tooth count and at least a stock pinion gear having a stock diameter and tooth count, comprising the steps of:
removing the stock sun gear;
removing the stock pinion gear;
installing a replacement sun gear, the replacement sun gear having an increased tooth count and an increased diameter as compared to the stock sun gear; and
installing a replacement pinion gear, the replacement pinion gear having a decreased tooth count and a decreased diameter as compared to the stock pinion gear;
wherein the replacement sun gear and the replacement pinion gear are capable of meshing with the existing ring gear.

8. The method of claim 7, wherein the replacement sun gear has 57 teeth and the replacement pinion gear has 23 teeth.

9. The method of claim 7, further including the step of installing a replacement carrier, the replacement sun gear and the replacement pinion gear being supported by the replacement carrier, the replacement carrier having notches that have a reduced size as compared to stock notches.

10. The method of claim 9, wherein the replacement carrier defines spindle receiving holes, wherein the spindle receiving holes are located along a larger diameter pattern as compared to a stock carrier and the material thickness in the area surrounding the spindle receiving holes is increased as compared to the stock carrier.

11. The method of claim 7, further including the step of installing a replacement spindle, wherein the replacement pinion gear is disposed about the replacement spindle, wherein the replacement spindle has a reduced diameter as compared to a stock spindle.
